(19) United States
(12) Patent Application Publication
(10) Pub. No.: US 2003/0174403 A1
(43) Pub. Date: Sep. 18, 2003

(54) Tunable optical filter array and method of use

(76) Inventors: Michael J. Yadlowsky, Corning, NY (US); George F. Wildeman, Painted Post, NY (US)

Correspondence Address: VOLENTINE FRANCOS, P.L.L.C., SUITE 150, 12200 SUNRISE VALLEY DRIVE, RESTON, VA, 20191, US

(21) Appl. No.: 10/100,463

(22) Filed: Mar. 15, 2002

(51) Int. Cl. G02B 27/00; G02B 1/10

(52) U.S. Cl. 359/578; 359/587

(57) ABSTRACT

According to an exemplary embodiment of the present invention, an optical apparatus includes an optical filter array which comprises a plurality of optical filter elements, wherein at least one of the optical filter elements is adapted for tuning to two or more wavelengths.

According to another exemplary embodiment of the present invention, an optical apparatus includes a monolithic optical filter array which further includes at least one tunable optical filter element. The optical apparatus also includes a tuning mechanism which tunes the tunable optical filter element to extract a signal of a particular wavelength from an optical signal which includes a plurality of wavelengths.

According to another exemplary embodiment of the present invention, a method for selectively extracting optical signals of particular wavelengths includes providing a monolithic optical filter array which further includes at least one tunable optical filter element. The method also includes tuning the tunable optical filter element to extract a signal of a particular wavelength from an optical signal which includes a plurality of wavelengths.

### CROSS-REFERENCE TO RELATED APPLICATIONS

The present application is related to U.S. patent application Ser. No. (Attorney Docket Nos.: CRNG.029 and CRNG.031) entitled “Monolithic Filter Array” and “Optical Filter Array and Method of Use,” respectively, and filed on even date herewith. The inventions described in these applications are assigned to the assignee of the present invention, and the disclosures of these applications are incorporated by references herein and for all purposes.

### FIELD OF THE INVENTION

The present invention relates generally to optical communications, and particularly to a monolithic tunable optical filter array and its method of use.

### BACKGROUND OF THE INVENTION

Optical transmission systems, including optical fiber communication systems, have become an attractive alternative for carrying voice and data at high speeds. In addition to the pressure to improve the performance of optical communication systems, there is also increasing pressure on each segment of the optical communication industry to reduce costs associated with building and maintaining an optical network.

One technology used in optical communication systems is wavelength division multiplexing (WDM). As is well known, WDM pertains to the transmission of multiple signals (in this case optical signals) at different wavelengths down a single waveguide, providing high-channel capacity. Typically, the optical waveguide is an optical fiber.

For purposes of illustration, according to one International Telecommunications Union (ITU) grid a wavelength band from 1530 mn to 1565 nm is divided up into a plurality of wavelength channels, each of which have a prescribed center wavelength and a prescribed channel bandwidth; and the spacing between the channels is prescribed by the ITU grid. For example, one ITU channel grid has a channel spacing requirement of 100 GHz (in this case the channel spacing is referred to as frequency spacing), which corresponds to channel center wavelength spacing of 0.8 nm. With 100 GHz channels spacing, channel “n” would have a center frequency 100 GHz less than channel “n+1” (or channel n would have a center wavelength 0.8 nm greater than channel n+1). The chosen channel spacing may result in 40, 80, 100, or more wavelength channels across a particular passband.

In WDM systems it may be useful to employ tunable optical filters in this demultiplexing process. For example, tuneable optical filters may be useful in reconfigurable optical networks to facilitate a number of operations including demultiplexing. Moreover, the drive to reduce network costs and operation costs has placed a value on flexibility that has not previously existed; and that may be provided by tuneable optical filters.

Unfortunately known tunable optical filters suffer certain implementation and performance drawbacks (e.g., suitably sharp cutoff outside of the passband of the filter; suitably low polarization dependent loss; and suitably low chromatic dispersion, some or all of which tend to degrade over the tuning range of conventional tunable filters).

Because the known tuneable optical filters have unacceptable drawbacks, there exists a need for optical filter elements which overcome at least the drawbacks described above.

### SUMMARY OF THE INVENTION

According to an exemplary embodiment of the present invention, an optical apparatus includes an optical filter array which comprises a plurality of optical filter elements, wherein at least one of the optical filter elements is adapted for tuning to two or more wavelengths.

According to another exemplary embodiment of the present invention, an optical apparatus includes a monolithic optical filter array which further includes at least one tunable optical filter element. The optical apparatus also includes a tuning mechanism which tunes the tunable optical filter element to extract a signal of a particular wavelength from an optical signal which includes a plurality of wavelengths.

According to another exemplary embodiment of the present invention, a method for selectively extracting optical signals of particular wavelengths includes providing a monolithic optical filter array which further includes at least one tunable optical filter element. The method also includes tuning the tunable optical filter element to extract a signal of a particular wavelength from an optical signal which includes a plurality of wavelengths.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1(a) is a perspective view of a thermally tuned optical filter array in accordance with an exemplary embodiment of the present invention.

FIG. 1(b) is a graph of the 2 dB center wavelength versus temperature for an optical filter element in array in accordance with an exemplary embodiment of the present invention.

FIG. 2 is a perspective view of an angle-tuned filter array in accordance with an exemplary embodiment of the present invention.

FIG. 3 is a representative view of WDM signals over a tuning range incorporating a plurality of tunable filter elements in accordance with an exemplary embodiment of the present invention.

### DEFINED TERM

As used herein the term “monolithic optical filter array” pertains to a plurality of optical filter elements formed in a common substrate.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

Briefly, in accordance with exemplary embodiments of the present invention described herein, the present invention relates to optical apparatus comprising a monolithic structure which includes a plurality of tunable optical filter elements, an apparatus for extracting optical signals including the optical apparatus, and a method for extracting optical signals using the optical apparatus.

Advantageously, the optical filter array in accordance with exemplary embodiments described herein enables substantially continuous tuning over a wavelength range using coarse and fine tuning as is described in detail below.

Illustratively, the monolithic structure includes a plurality of optical filters, wherein at least one of the optical filters is adapted for tuning at two or more wavelengths. In its use as an apparatus for extracting optical filters, the optical filter array includes a tuning mechanism which selectively tunes at least one tunable optical filter enabling the separation of a particular wavelength channel from an optical signal that includes a plurality of wavelength channels. Moreover, a method of use of the apparatus enables selective extraction of a particular wavelength channel from an optical signal which includes a plurality of wavelength channels. Illustratively, the optical signal is a wavelength division multiplexed (WDM) or dense wavelength division multiplexed (DWDM) signal.

The present invention may be properly described through the use of illustrative embodiments described presently. It is noted that the illustrative embodiments, including the tuning mechanisms described, as well as the optical filter elements and the materials from which they are monolithically formed, are for purposes of illustration, and not limitation. These alternatives will be readily apparent to one having ordinary skill in the art having had the benefit of the present disclosure and are considered to be within the scope of the present invention as defined by the claims appended hereto.

For example, as will become more clear as the present invention proceeds, the optical filters in accordance with exemplary embodiments of the present invention may be reflective-type filters, transmissive-type filters or a combination of different reflection-type filters and/or transmissive-type filters.

It is noted that for purposes of facility of discussion, the disclosure of the present invention will focus on reflective-type filters, although it is to be understood that transmissive-type filters may be used as well. A salient feature of the optical filters in accordance with exemplary embodiments of the present invention is the capability of monolithic fabrication of tunable optical filter elements using various materials.

It is further noted (again for clarity of discussion) that the present disclosure focuses primarily on the use of optical filters of the present invention in multiplexing/demultiplexing applications in optical communication systems. However, the optical filters of the present invention have utility in a variety of other applications.

For example, the inventive optical apparatus also could be used in EDFA applications where the amplifier operates over a relatively wide bandwidth. For example, the tuneable optical filters of an exemplary embodiment of the present may be used to reject ASE from EDFA's, particularly pre-amplified receivers.

Additionally, the inventive optical apparatus may be deployed to filter out ASE in a deployed laser. As is known, as the wavelength of a laser drifts over time and temperature, it is necessary to change the filter to match the wavelength of the laser. This synchronization is needed for long periods of time in deployed systems. In accordance with an exemplary embodiment of the present invention, laser drift may be accommodated for by coarse tuning to a particular optical filter element of the monolithic optical filter array, and be finely tuning the chosen optical filter element over a particular wavelength range that the laser may drift.

Alternatively the optical apparatus in accordance with an exemplary embodiment of the present invention could be a tuneable dispersion compensator. To this end, at least one of the optical filter elements of the monolithic optical filter array would illustratively would be a chirped grating, such as a chirped Bragg grating. The grating could be linearly or non-linearly chirped, and could be finely tuned by techniques described herein. Moreover, a plurality of such gratings could be used in which coarse tuning and fine tuning could be carried out by techniques described herein.

It is further noted that the above examples of the utility of the monolithic optical filter arrays of the present invention are merely illustrative, and are intended to be in no way limiting of the present invention. Clearly, other implementations of the monolithic optical filter array will be readily apparent to one of ordinary skill in the art who has had the benefit of applicants' disclosure.

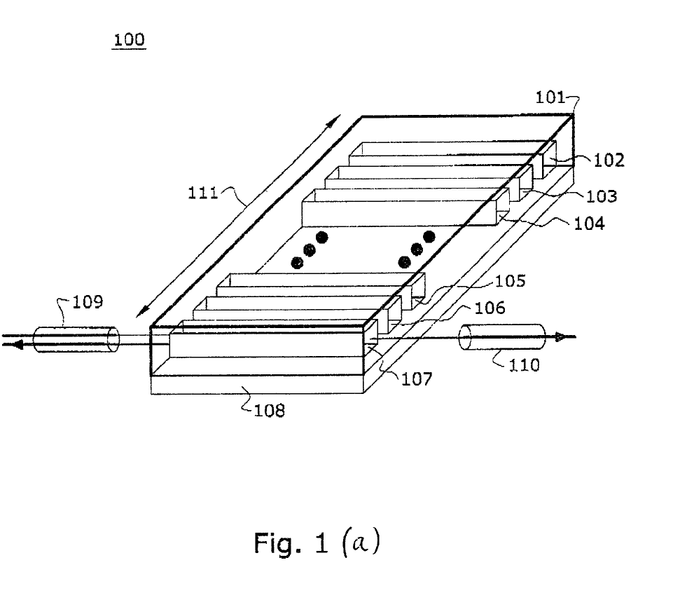

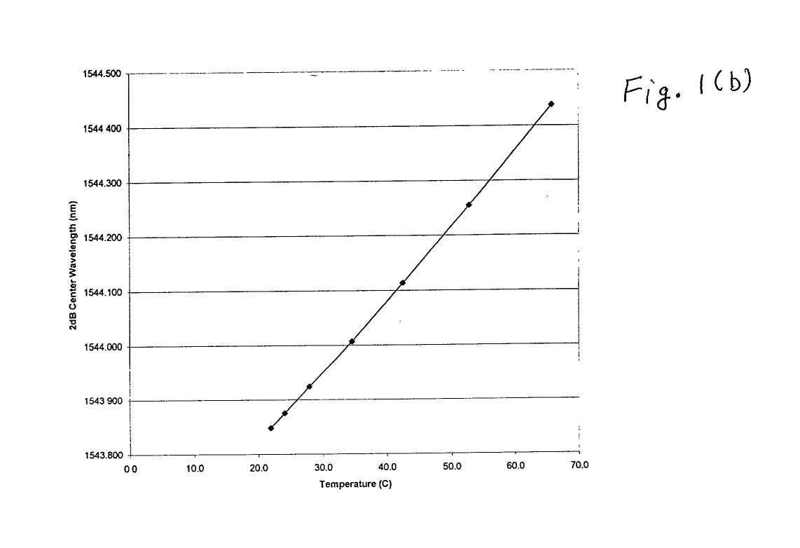

FIG. 1(a) shows an exemplary embodiment of the present invention in which a thermally tuned optical filter apparatus 100 includes a monolithic optical filter array 101 which further includes a plurality of optical filter elements. The monolithic optical filter array 101 comprises N optical filter elements (N=integer) 102, 103, 104, 105, 106, 107 for n-wavelength channels having center wavelengths λ₁, . . . , λₙ. For purposes of illustration, n and N may be 40, 80, 100, 200 or 400. Of course, this is merely illustrative and intended to be in no way limiting of the present invention.

Illustratively, the N optical filter elements 102-107 are reflective filter elements. For example, the optical filter elements 102 may be Bragg gratings such as those described in detail in U.S. patent application Ser. No. 09/874,721, entitled “Bulk Internal Bragg Gratings and Optical Devices,” to Bhagavatula, et al., and filed on Jun. 5, 2001. Moreover, the substrate 103 in which the optical filter elements are monolithically formed may be a glass material such as those taught in U.S. patent application Ser. No. 09/874,352, entitled “UV Photosensitive Melted Germano-Silicate Glass,” to Borrelli, et al., and filed on Jun. 5, 2001; or may be one of the glass material as taught in U.S. patent application Ser. No. (Attorney Docket No.: CRNG.034/SP01-222A) and entitled “UV Photosensitive Melted Glasses” to Nicholas Borrelli, et al, filed on even date herewith. The inventions described in these referenced U.S. Patent Applications are assigned to the Assignee of the present invention, and the disclosures of these applications are specifically incorporated by reference herein and for all purposes.

It is noted that there are advantageous characteristics of the glass monolithic optical filter elements 102-107 in accordance with the presently described exemplary embodiments that are described in the above referenced application entitled “Optical Filter Array and Method of Use.” Further details of such advantageous characteristics are found therein.

It is noted that the above referenced gratings and materials are intended to be illustrative of an in no way limiting of the scope of the present invention. To wit, other materials to include polymers, such as fluorinated acrylate; porous glass, such as doped porous glasses, which are consolidated at a relatively high temperature; and dichromated gelatin may be used as the substrate in which the N filter elements 102-107 may be formed. Finally, it is noted that all of the above referenced materials and optical filter elements may be used in accordance with other exemplary embodiments described herein.

In accordance with the exemplary embodiment shown in FIG. 1(a), a thermal element 108 is disposed proximate to filter elements 102-107. Thermal element 108 is illustratively a thermoelectric cooler (TEC), such as Peltier effect thermoelectric cooler, and is used to modulate the temperature of the optical filter elements 102-107 in a manner described herein. Of course, the selection of a TEC for the thermal element 108 is merely illustrative, and other thermal elements could be used to effect thermal tuning of the optical filter elements while keeping within the purview of the present invention. For example, thin-film heating elements may be used in this capacity.

It is further noted that in the exemplary embodiment shown in FIG. 1(a), all filter elements are tuned using a single thermal element 108 disposed beneath the monolithic optical filter array 101. This is also merely illustrative. To wit, the thermal element 108 could comprise a plurality of individual elements, each of which thermally tunes a certain number (i.e. two or more) of the optical filter element 102-107. Moreover, the thermal element, or a plurality of thermal elements as referenced immediately above, could be disposed over the top surface of the monolithic optical array. This placement of such a thermal element(s) could be instead of or in addition to thermal element 108 shown disposed beneath the monolithic optical filter array 101 in FIG. 1(a). Finally, it is noted that it is possible to have individual thermal elements for each optical filter element.

In operation, an optical signal from an input/output collimator 109 is incident upon a selected one of the filter elements 107. The input optical signal from input collimator 107 includes a plurality of optical channels. For example, the input optical signal could be a WDM or a DWDM optical signal having channels 1, . . . , n, which have respective center wavelengths λ₁, . . . , λₙ. In the exemplary embodiment shown in FIG. 1(a) wherein the filter elements 102-107 are illustratively reflective filter elements, a selected one of said channels is reflected by the selected optical filter element 107 and is incident upon input/output collimator 109. The remaining optical channels are transmitted through the chosen filter element, and are incident upon an output collimator 110. It is noted that a variety of input/output devices may be used for input/output collimator 109 and output collimator 110. Moreover, certain techniques may be used to reduce specular reflection. Further details of these input/output devices as well as techniques to reduce specular reflections may be found in the above referenced application entitled “Optical Filter Array and Method of Use.” It is further noted that these referenced input/output devices and techniques may be used in conjunction with other exemplary embodiments described herein.

As will become more clear as the present description proceeds, each of the filter elements 102-107 is designed for thermal tuning over two or more wavelength channels. As such two or more wavelength channels may be reflected by the particular optical filter element chosen depending upon the shifting of the effective optical periodicity by thermal effects of the thermal element 108. To wit, the thermal variance may change the refractive index and/or the physical periodicity of the Bragg grating of the optical filter element, thereby changing its resonant wavelength. It is noted that the thermal tuning results in the fine tuning of the optical apparatus 100.

Coarse tuning is effected by the one-dimensional motion 111 and alignment of the input/output collimator 109 and the output collimator 110 to a particular optical filter element. Consequently, the coarse tuning of the optical apparatus involves the selection of a particular optical filter element which will reflect a particular number of channels. Reflection of the desired one particular wavelength channel (i.e., fine tuning) entails the thermal tuning described above.

To effect the motion of the input/output collimator 109 and the output collimator 110, an electronically controlled mechanical device such as a stepper motor could be used. Further details of such a device may be found in the above referenced application entitled “Optical Filter Array and Method of Use.”

The control of the motion of the input/output collimator and output collimator is illustratively carried out as follows. A microcontroller (not shown) may access a look-up table which contains the reflection wavelength band of each of the individual filter elements over a particular temperature range. A translation stage illustratively moves either the input/output collimator 109 and output collimator, or the monolithic optical filter array 101 in one direction 111 so that selected one of filter elements 102-107 is properly aligned with the input/output collimator 109. Thereafter thermal tuning maybe effected to fine tune the optical filter element to reflect a desired frequency/wavelength channel.

In accordance with the exemplary embodiment of FIG. 1(a), coarse (mechanical) and fine (thermal) tuning are carried out enabling wavelength channel selection over a prescribed passband in a manner which affords significant advantage over conventional methods/apparati.

For example, the illustrative embodiment enables adjustment of the wavelength of each filter element to accommodate for manufacturing induced variations in the center wavelength of a wavelength channel. Moreover, the present invention as described with the illustrative embodiments enables continuous or nearly continuous tuning over a relatively wide range (e.g. 30 nm-80 nm).

Furthermore, because each individual filter requires a relatively small amount of tuning for each filter element can be used to simplify the control system which serves to ensure that the filter device is at a target wavelength within a prescribed absolute tolerance. Typically, the application of the filter device dictates the accuracy with which the filter must be set (e.g., WDM systems illustratively require 5 GHz of filter de-tuning). The broader the range over which the filter device must operate, the more difficult it becomes to maintain particular absolute accuracy.

By virtue of the present invention the tuning range illustratively may be may be reduced from approximately 40 nm for a conventional single tunable filter to approximately 0.4 nm to approximately 1.2 mn for the optical filter elements (e.g., filter elements 102-107) of the present invention. To this end, 0.4 nm is the approximate range for a 50 GHz system (i.e., 0.4 nm at 1550 nm) if a tuneable optical filter elements are targeted to be nominally between the 50 GHz channels. Then the adjacent channels are spaced approximately 25 GHz apart for a total of approximately 50 GHz or 0.4 nm.

Of course, the 0.4 nm tuning range pertains to two channels in the present illustrative embodiment. Three channels could be reached by targeting a particular tuneable optical filter element for a specific channel and tuning up or down 50 GHz (i.e. over 100 GHz), requiring a tuning range of 0.8 nm. To go to four channel tuning per tuneable optical filter element, it is necessary to tune 25 GHz to the adjacent channel plus 50 GHz to the next channel for a total of 75 GHz in each direction. The total range of 150 GHz requires a tuning range of 1.2 nm.

Turning to FIG. 1(b), a graph of an illustrative fine tuning range for an illustrative optical filter element of an embodiment of the present invention using thermal tuning is shown. To this end, the 2 dB center wavelength versus temperature for an optical filter element of a monolithic optical filter array formed in a glass substrate according to an exemplary embodiment is shown. The temperature tuning in the present example is 0.013 nm per ° C. For 0.4 nm tuning a temperature change of approximately 31° C. is needed; for the illustrative optical filter element to be tuneable over three channels would require a temperature change of 62° C.; and tuning over four channels would require a temperature change of 93° C.

It is noted that the above described data shown in FIG. 1(b) is illustrative, and other glass materials may exhibit different tuning characteristics over temperature. Moreover, it is noted that materials other than glass may have different tuning characteristics. For example, polymer materials generally exhibit a greater temperature sensitivity; thus, a smaller temperature variation will result in a greater wavelength/frequency change compared to the glass material referenced in connection with FIG. 1(b).

Beneficially the above described illustrative tuning range of the tuneable optical filter elements of an exemplary embodiment of the present invention results in a significant reduction of the required accuracy of the control system.

Moreover, the fine tuning may be used to reduce the center wavelength tolerance of the optical filter elements. A temperature offset could be stored in the controller, and used to correct the nominal temperature to which the filter element is set for a particular target wavelength.

Finally, as previously discussed, coarse tuning is effected by the motion of the input/output collimator 109 relative to the monolithic optical filter array. This may be achieved by methods described above. The individual optical filter elements 102-107 are approximately 0.1 mm to approximately 1.0 mm in cross-section for typical WDM applications. The alignment tolerances for the optical apparatus should be roughly 10 times finer than this. This degree of tolerance is well within the capabilities of stepper motors, DC motors and linear solenoids discussed in the referenced application.

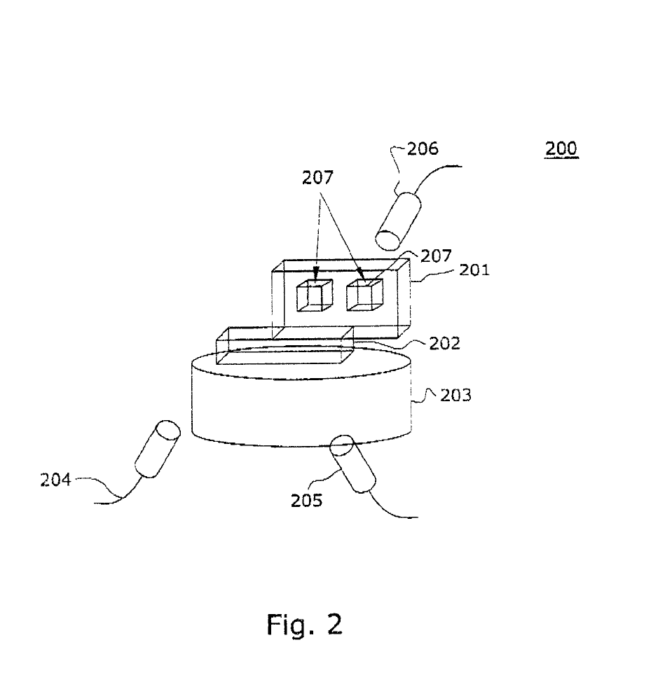

FIG. 2 shows an angle tuned filter apparatus 200 according to an exemplary embodiment of the present invention. A filter element array 201 is disposed in close proximity to a filter selector 202. A rotation stage 203 is selectively rotated by a rotation mechanism (not shown) to orient the angle of incidence of light from an input collimator 204 upon the frequency selector 202, and therefore to a particular filter element 207 in the optical filter array 201. The optical signal from the input collimator 204 includes a plurality of wavelengths. Illustratively, the optical signal is a WDM or DWDM optical signal which may have 40, 80, 100 (or more) wavelength channels, with each wavelength channel having a center wavelength. In this illustrative embodiment, one of the center wavelengths is reflected from the selected filter element and is incident upon a first output collimator 205. All remaining wavelengths are transmitted through the filter element 207, and are incident upon an output collimator 206. These transmitted signals may be further demultiplexed by a similar technique, and using a cascaded apparatus which is similar to the angled tuned filter apparatus of the illustrative embodiment shown in FIG. 2.

The optical filter array 201 in accordance with an exemplary embodiment shown in FIG. 2 illustratively includes two optical filter elements 207. Each filter element 207 is designed to be tunable over a defined portion of the frequency/wavelength band of the input optical signal from input collimator 204. Moreover, it is noted that the use of two filter elements 207 in the optical filter array 201 is merely illustrative, and is no way limiting of the invention. To this end, depending upon the application, as well as the tunability of the filter elements, more than two filter elements could be used to form the filter array. It is further noted that the array could have a series of rows and columns, and that a plurality of individual substrates could be stacked or sequentially arranged.

The use of individual substrates usefully relieves manufacturing yields since the failure of an optical filter element wastes fewer collocated filter elements. Further details of the fabrication of a monolithic optical filter array having rows and columns of filter elements; and of the arrangement of a plurality of individual optical filter arrays in a stacked arrangement are described in the above referenced application, entitled “Optical Filter Array and Method of Use.”

It is noted that angled tuned filter apparatus 200 of the exemplary embodiment shown in FIG. 2 has a coarse tuning capability and a fine tuning capability. To this end, coarse tuning refers to the alignment of the input collimator 204 to one of the filter elements 207. This coarse tuning enables the selection of one of the optical filter elements 207 from the plurality thereof, which may be tuned to reflect more than one wavelength channel. Fine tuning is illustratively carried out by rotation of the rotation stage so that light from the input collimator 204 is oriented at a particular angle of incidence relative to the chosen filter element 207. By choosing the suitable angle of incidence, the reflection of the particular desired wavelength channel is effected.

In operation, a microcontroller (not shown) may be used to control the rotation of the rotation stage 203. Specifically, the microcontroller may access a look-up table which stores coarse tuning and fine tuning information. To this end, the look-up table could store specific rotational positions of the rotation stage 203 for each optical filter element 207 and the corresponding wavelength channels the filters element 207 will reflect at particular angles of incidence of the input collimator 204.

For purposes of illustration, if the input signal from input collimator 204 includes wavelength channels 1, . . . , 5 with corresponding wavelengths λ₁-λ₅, and it is desired to reflect wavelength channel 3 having center wavelength λ₃ to the first output collimator 205, the microcontroller can look up the desired rotational position of the rotation stage 203 relative to one of the two filter elements 207 and command the rotation stage 203 to move to that position. Extraction of any other wavelength channel having a particular center wavelength could be similarly effected. Finally, it is noted that precise rotation of the rotation stage to effect orientation of the input collimator 204 and filter selector relative to a particular filter element 207 of the optical filter array 201 may be carried out using a stepper-motor, DC motor or similar device. Moreover an encoder may be used to provide feedback.

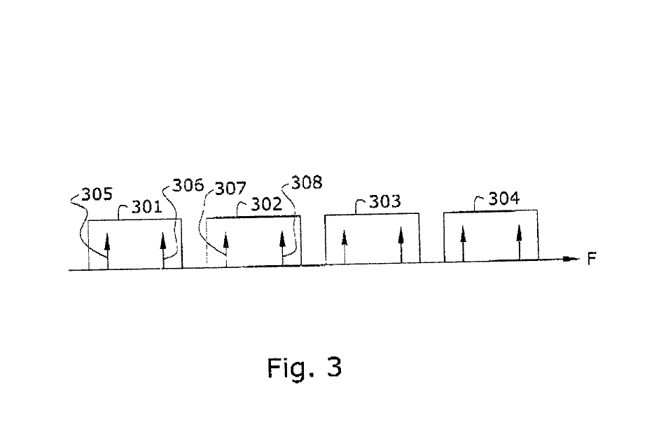

Turning to FIG. 3, a representative view of the frequency (F) for four filter elements 301, 302, 303 and 304. Illustratively, these filter elements are identical to those described in connection with the exemplary embodiment of FIG. 2. In this rather straight forward but illustrative example of the present invention, the thermal tuning range of each element 301-304 may be engineered to be slightly greater than one full channel spacing. To wit, the first filter element 301 may be designed to reflect a first wavelength channel having a frequency 305 and a second wavelength channel having a frequency 306. Likewise, the second filter element 302 would reflect a third frequency 307 and a fourth frequency 308. By design, the first frequency 305 could be chosen to correspond to a center wavelength of a first channel, while the second frequency 306 could be chosen to correspond to a center wavelength of a second wavelength channel. Likewise, third frequency 307 and fourth frequency 308 would correspond to third and fourth wavelength channels of the optical signal. Similarly, the frequencies of third filter 303 and fourth filter 304 would correspond to other wavelength channels.

As can be readily appreciated, by virtue of the thermally tuned filter elements in accordance with the present exemplary embodiment of the invention, the number of filter elements needed would be approximately one-half of the total number of channels. In conventional thermally tuned filters, the filters are engineered so that the full temperature tuning range is equal to the full desired tuning range. As practical temperature ranges are within approximately 50° C. to approximately 100° C., this requires a large change in filter center wavelength per degree Celsius. This in turn requires exceedingly great temperature stability and resolution.

However, in accordance with the present exemplary embodiment of the invention, with the tuning range being equal to only one channel spacing, the required resolution to tune the filter is greatly relaxed. The filter also becomes less sensitive to thermal transients and manufacturing variations. Finally, it is noted that a representative diagram of the frequency selectivity of the tunable optical filters which are shown in FIG. 3 and described in connection with thermal tuning may also be readily be ascertained for the angle tuned filter apparatus 100 of the exemplary embodiment of FIG. 1(a). Again, advantageously, the angle tuning enables the reduction in the number of filters required to accommodate extraction of frequency/wavelength across a particular range by having tunable optical filters which can be tuned to reflect more than one frequency.

It is noted that in addition to the reflective and transmissive filters referenced in conjunction with the exemplary embodiments described above, the filter elements may be tunable micro-electromechanical (MEM's) based filters. Moreover, it is noted that in the illustrative embodiments described thus far, the optical filter arrays are comprised of filter elements based upon the same technology. It is noted that this is not necessarily the case, as a variety of such elements based on more than one of the referenced technologies may be incorporated into the same substrate to form an optical filter array.

The invention having been described in detail in connection through a discussion of exemplary embodiments, it is clear that modifications of the invention will be apparent to one having ordinary skill in the art having had the benefit of the present disclosure. Such modifications and variations are included in the scope of the appended claims.

We claim:

1. An optical apparatus, comprising:
a monolithic optical filter array which includes a plurality of optical filter elements wherein at least one of said plurality of optical filter elements is adapted for selective tuning at two or more wavelengths.

2. An optical apparatus as recited in claim 1, wherein said plurality of optical filters are reflective-type filters.

3. An optical apparatus as recited in claim 1, wherein said plurality of optical filters are transmissive-type filters.

4. An optical apparatus as recited in claim 1, wherein said selective tuning enables extraction of a desired wavelength from an optical signal which is comprised of a plurality of optical wavelengths.

5. An optical apparatus as recited in claim 1, wherein said plurality of optical filter elements are chosen from the group consisting essentially of:
Bragg gratings; holographic gratings; and
micro-electromechanical filters.

6. An optical apparatus as recited in claim 1, wherein said selective tuning is effected by altering an angle of incidence of light upon a selected one of said optical filter elements.

7. An optical apparatus as recited in claim 1, wherein said selective tuning is effected by thermal variation of a selected one of said optical filter elements.

8. An optical apparatus as recited in claim 1, wherein said optical filter elements of said monolithic optical filter array are formed in a substrate of a material chosen from the group consisting essentially of:
melted glass; dichromated gelatin; polymers; and porous glass.

9. An optical apparatus as recited in claim 4, wherein said optical signal is a WDM signal, and said desired wavelength further comprises a wavelength channel.

10. An optical apparatus as recited in claim 4, wherein the optical apparatus is a dispersion compensator.

11. An optical apparatus as recited in claim 4, wherein said optical signal is an output of a laser, and said plurality of wavelengths are the output wavelengths of said laser.

12. An optical apparatus as recited in claim 1, wherein said monolithic optical filter array further comprises an N×M array of said optical filter elements, where N and M are integers.

13. An optical apparatus as recited in claim 12, wherein N=1, and M=40.

14. An optical apparatus, comprising:
a monolithic optical filter array which includes at least one tunable optical filter element; and
a tuning device which tunes said at least one tunable optical filter to extract a signal of a particular wavelength from an optical signal which includes a plurality of wavelengths.

15. An optical apparatus as recited in claim 14, wherein said monolithic filter includes an array of said optical filter elements.

16. An optical apparatus as recited in claim 14, wherein said tuning device further comprises a coarse tuning device, and a fine tuning device.

17. An optical apparatus as recited in claim 16, wherein said coarse tuning device moves an input/output device in one dimension thereby aligning said input/output device with one of said at least one optical filter elements.

18. An optical apparatus as recited in claim 17, wherein said fine tuning device further comprises a device which alters a temperature of said one of said at least one optical filter elements so that said one optical filter element reflects light of a selected wavelength.

19. An optical apparatus as recited in claim 18, wherein said selected wavelength is a wavelength channel of a WDM optical signal.

20. An optical apparatus as recited in claim 16, wherein each of said at least one optical filter elements may be tuned by said fine tuning device to reflect one of at least two wavelengths.

21. An optical apparatus as recited in claim 16, wherein said fine tuning device further comprises an angle tuning device which selectively aligns said input/output device to receive reflected light of said selected wavelength.

22. An optical apparatus as recited in claim 14, wherein said optical filter array further comprises a plurality of said optical filter elements, which are chosen from the group consisting essentially of:
Bragg gratings; holographic gratings; and
micro electromechanical filters.

23. An optical apparatus as recited in claim 14, wherein said at least one optical filter element of said monolithic optical filter array are formed in a substrate of a material chosen from the group consisting essentially of:
melted glass; dichromated gelatin; polymers; porous glass.

24. An optical apparatus as recited in claim 14, wherein said monolithic optical filter array further comprises an N×M array of said optical filter elements, where N and M are integers.

25. An optical apparatus as recited in claim 24, wherein the apparatus further comprise a plurality of said optical filter arrays.

26. An optical apparatus as recited in claim 14, wherein the optical apparatus is a tuneable dispersion compensator.

27. A method for selectively extracting optical signals of particular wavelengths, comprising:
providing a monolithic optical filter array which includes at least one tunable optical filter; and
tuning said at least one tunable optical filter array to extract a signal of a particular wavelength from an optical signal which includes a plurality of wavelengths.

28. A method as recited in claim 27, wherein said tuning further comprises:
aligning an input/ouput device to one of said optical filters; and
tuning said one optical filter to reflect light of said particular wavelength.

29. A method as recited in claim 27, wherein said tuning further comprises coarse tuning and fine tuning.

30. A method as recited in claim 29, wherein said coarse tuning further comprises moving an input/output device in one dimension to aligning said input/output device with one of said at least one optical filter elements.

31. A method as recited in claim 29, wherein said fine tuning further comprises altering a temperature of said one of said at least one optical filter elements so that said one optical filter element reflects light of a selected wavelength.

32. A method as recited in claim 29, wherein said fine tuning further comprises angle tuning said input/output device to receive reflected light of said selected wavelength.
